(19) United States
(12) Patent Application Publication
(10) Pub. No.: US 2026/0019878 A1
(43) Pub. Date: Jan. 15, 2026

(54) SIGNAL TRANSFER SYSTEM, BASE STATION APPARATUS, TRANSFER CONTROL APPARATUS AND SIGNAL TRANSFER METHOD

(71) Applicant: NTT, Inc., Tokyo (JP)

(72) Inventors: Kenji MIYAMOTO, Musashino-shi (JP); Yoshihito SAKAI, Musashino-shi (JP); Tatsuya SHIMADA, Musashino-shi (JP)

(73) Assignee: NTT, Inc., Tokyo (JP)

(21) Appl. No.: 18/997,868

(22) PCT Filed: Jul. 29, 2022
(86) PCT No.: PCT/JP2022/029263

§ 371 Date: Jan. 23, 2025

(51) Int. Cl. H04W 28/12

(52) U.S. Cl. CPC H04W 28/12

(57) ABSTRACT

A signal transfer system that transfers a signal from one communication device to another communication device includes: an information acquisition unit that acquires network transfer information that is information regarding a traffic flow from the one communication device for each traffic flow from the one communication device to the another communication device; and a communication control unit that executes adjustment processing of controlling transmission of a frame in the one communication device so as to reduce a waiting time for the frame on a basis of the network transfer information acquired by the information acquisition unit.

### TECHNICAL FIELD

The present invention relates to a signal transfer system, a base station apparatus, a transfer control apparatus, and a signal transfer method.

### BACKGROUND ART

In signal transmission in a conventional mobile communication system, in a case where a base station and a wireless terminal exchange signals, time division duplex (TDD) in which a downlink signal and an uplink signal are alternately transmitted in a time domain is used, and at that time, transmission and reception of signals are performed in units of radio transmission frames called transport blocks.

### CITATION LIST

### Non Patent Literature

Non Patent Literature 1: 3GPP TS 38.300 V16.7.0″, 3GPP, 2021.
Non Patent Literature 2: 3GPP TS 38.214 V16.7.0″, 3GPP, 2021.
Non Patent Literature 3: “IEEE Standard for Local and metropolitan area networks-Bridges and Bridged Networks-Amendment 25: Enhancements for Scheduled Traffic”, IEEE Computer Society, IEEE Std 802.1Qbv-2015, IEEE, 2015.

### SUMMARY OF INVENTION

### Technical Problem

However, jitter may occur due to an uplink transmission waiting time during uplink transmission in TDD or a waiting time for forming a transport block in a case where a size of the transport block is larger than a frame size output from a function of an application layer in a wireless terminal. This is because, for example, even if each uplink traffic flow is transferred to a function of a media access control (MAC) layer in a terminal in a state where the frame transmission interval is matched and jitter is small in an output from the function of the application layer in the wireless terminal, jitter may occur due to the above-described waiting time.

As a result, end-to-end jitter may increase due to jitter in a wireless transmission section. Note that such a circumstance is not limited to a mobile communication system, and is a common issue in communication between communication devices.

In view of the above circumstances, an object of the present invention is to provide a technology capable of reducing an increase in jitter.

### Solution to Problem

One aspect of the present invention is a signal transfer system that transfers a signal from one communication device to another communication device, the signal transfer system including: an information acquisition unit that acquires network transfer information that is information regarding a traffic flow from the one communication device for each traffic flow from the one communication device to the another communication device; and a communication control unit that executes adjustment processing of controlling transmission of a frame in the one communication device so as to reduce a waiting time for the frame on a basis of the network transfer information acquired by the information acquisition unit.

One aspect of the present invention is a signal transfer system that transfers a signal from one communication device to another communication device, the signal transfer system including: a transfer unit that transfers the signal; an information acquisition unit that acquires network transfer information that is information regarding a traffic flow from the one communication device for each traffic flow from the one communication device to the another communication device; and a transfer control unit that executes adjustment processing of controlling transfer of a frame in the transfer unit so as to reduce a waiting time for the frame on a basis of the network transfer information acquired by the information acquisition unit.

One aspect of the present invention is a base station device that is wirelessly connected to one communication device and transfers a signal transmitted from the one communication device to another communication device, the base station device including: an information acquisition unit that acquires network transfer information that is information regarding a traffic flow from the one communication device for each traffic flow from the one communication device to the another communication device; and a communication control unit that executes adjustment processing of controlling transmission of a frame in the one communication device so as to reduce a waiting time for the frame on a basis of the network transfer information acquired by the information acquisition unit.

One aspect of the present invention is a base station device that is wirelessly connected to one communication device and transfers a signal transmitted from the one communication device to another communication device, the base station device including: an information acquisition unit that acquires network transfer information that is information regarding a traffic flow from the one communication device for each traffic flow from the one communication device to the another communication device; and an information transmission unit that transmits the network transfer information to a transfer control device that executes adjustment processing of controlling transfer of a frame on a basis of the network transfer information so as to reduce a waiting time for the frame in a transfer unit that transfers the signal.

One aspect of the present invention is a transfer control device that controls a transfer unit that transfers a signal from one communication device to another communication device, the transfer control device including: an information acquisition unit that acquires network transfer information that is information regarding a traffic flow from a base station device wirelessly connected to the one communication device for each traffic flow from the one communication device to the another communication device; and a transfer control unit that executes adjustment processing of controlling transfer of a frame in a transfer unit that transfers the signal so as to reduce a waiting time for the frame on a basis of the network transfer information acquired by the information acquisition unit.

One aspect of the present invention is a signal transfer method for transferring a signal from one communication device to another communication device, the signal transfer method including: an information acquisition step of acquiring network transfer information that is information regarding a traffic flow from the one communication device for each traffic flow from the one communication device to the another communication device; and a communication control step of executing adjustment processing of controlling transmission of a frame in the one communication device so as to reduce a waiting time for the frame on a basis of the network transfer information acquired in the information acquisition step.

One aspect of the present invention is a signal transfer method for transferring a signal from one communication device to another communication device, the signal transfer method including: a transfer step of transferring the signal; an information acquisition step of acquiring network transfer information that is information regarding a traffic flow from the one communication device for each traffic flow from the one communication device to the another communication device; and a transfer control step of executing adjustment processing of controlling transfer of a frame in the transfer step so as to reduce a waiting time for the frame on a basis of the network transfer information acquired in the information acquisition step.

### Advantageous Effects of Invention

According to the present invention, it is possible to reduce an increase in jitter.

### BRIEF DESCRIPTION OF DRAWINGS

FIG. 1 is an explanatory diagram for describing an outline of a signal transfer system according to an embodiment.

FIG. 2 is a first explanatory diagram for describing an effect of adjustment processing in the embodiment.

FIG. 3 is a second explanatory diagram for describing an effect of the adjustment processing in the embodiment.

FIG. 4 is a block diagram illustrating a first application example of the signal transfer system according to the embodiment.

FIG. 5 is a flowchart illustrating an example of a flow of processing executed by the signal transfer system according to the first application example in the embodiment.

FIG. 6 is a block diagram illustrating a second application example of the signal transfer system according to the embodiment.

FIG. 7 is a flowchart illustrating an example of a flow of processing executed by the signal transfer system according to the second application example in the embodiment.

FIG. 8 is a block diagram illustrating an example of a hardware configuration of a transfer device according to the embodiment.

FIG. 9 is a block diagram illustrating an example of a configuration of a control unit included in the transfer device according to the embodiment.

FIG. 10 is a block diagram illustrating an example of a hardware configuration of a transfer device controller according to the embodiment.

FIG. 11 is a block diagram illustrating an example of a configuration of a control unit included in the transfer device controller according to the embodiment.

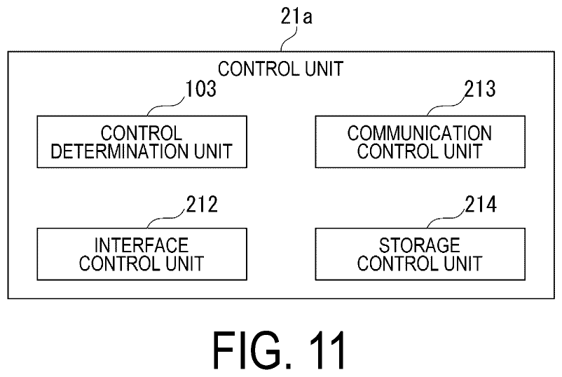

FIG. 12 is a block diagram illustrating an example of a hardware configuration of a base station according to the embodiment.

FIG. 13 is a block diagram illustrating an example of a configuration of a control unit included in the base station according to the embodiment.

FIG. 14 is a block diagram illustrating an example of a hardware configuration of a distributed station according to the embodiment.

FIG. 15 is a block diagram illustrating an example of a configuration of a control unit included in the distributed station according to the embodiment.

FIG. 16 is a block diagram illustrating an example of a hardware configuration of a wireless terminal according to the embodiment.

FIG. 17 is a block diagram illustrating an example of a configuration of a control unit included in the wireless terminal according to the embodiment.

FIG. 18 is a block diagram illustrating an example of a hardware configuration of a communication device according to the embodiment.

FIG. 19 is a block diagram illustrating an example of a configuration of a control unit included in the communication device according to the embodiment.

FIG. 20 is a block diagram illustrating a first application example of the signal transfer system according to a second modification of the embodiment.

FIG. 21 is a flowchart illustrating an example of a flow of processing executed by the signal transfer system according to a first application example of the second modification of the embodiment.

FIG. 22 is a block diagram illustrating a second application example of the signal transfer system according to the second modification of the embodiment.

FIG. 23 is a flowchart illustrating an example of a flow of processing executed by the signal transfer system according to the second application example of the second modification of the embodiment.

FIG. 24 is a block diagram illustrating an example of a hardware configuration of a wireless controller in the second modification of the embodiment.

FIG. 25 is a block diagram illustrating an example of a configuration of a control unit included in the wireless controller in the second modification of the embodiment.

### DESCRIPTION OF EMBODIMENTS

### Embodiment

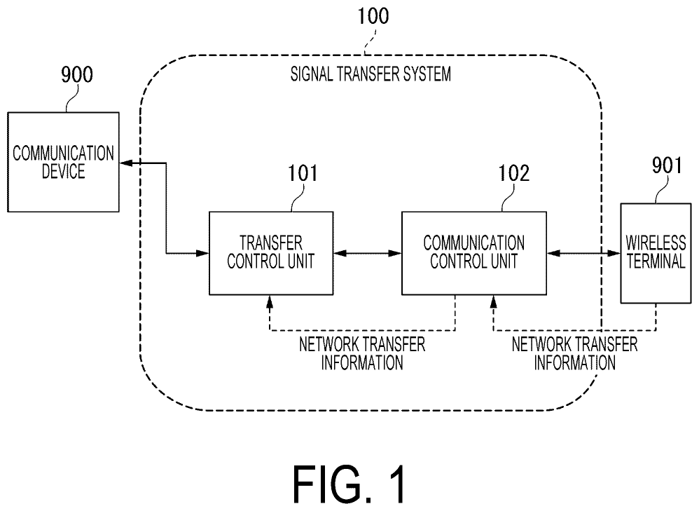

FIG. 1 is an explanatory diagram illustrating an outline of a signal transfer system 100 according to an embodiment. The signal transfer system 100 is a system that transfers a signal from one communication device to the other communication device. The signal transfer system 100 includes, for example, a transfer device, a base station, and a control device of the transfer device, and transfers a signal from a server to a wireless terminal and transfers a signal from the wireless terminal to the server. The signal transfer system 100 includes, for example, the transfer device, a distributed station, and the control device of the transfer device, and transfers a signal from a central station to a wireless terminal and transfers a signal from the wireless terminal to the central station. Application examples of such a signal transfer system 100 will be described in detail below, and first, an outline of the signal transfer system 100 will be described.

The signal transfer system 100 includes a transfer control unit 101 and a communication control unit 102. The transfer control unit 101 acquires network transfer information for each traffic flow from one communication device to the other communication device from the one communication device. The network transfer information is information regarding a traffic flow. The information regarding a traffic flow indicates, for example, a frame size and a transmission interval of a frame. Therefore, the network transfer information includes, for example, information indicating a frame size and a transmission interval of a frame. The frame size and the transmission interval of a frame indicated by the information indicating a frame size and a transmission interval of a frame are, for example, a frame size and a transmission interval of an uplink frame.

Note that the information regarding a traffic flow may further indicate, for example, a transmission rate or a destination address. Therefore, the network transfer information may include, for example, information indicating a transmission rate or information indicating a destination address.

One communication device is, for example, the above-described server, and in this case, the other communication device is, for example, a wireless terminal. In a case where one communication device is, for example, a wireless terminal, the other communication device is, for example, the above-described server. In the case of such communication between the server and the wireless terminal, a frame size of an uplink frame indicated by the network transfer information is, for example, a frame size of a frame from the wireless terminal to the server. That is, in such a case, uplink indicates a direction from the wireless terminal to the server in a propagation direction of a signal.

One communication device is, for example, the above-described central station, and in this case, the other communication device is, for example, a wireless terminal. In a case where one communication device is, for example, a wireless terminal, the other communication device is, for example, the above-described central station. In the case of such communication between the central station and the wireless terminal, a frame size of an uplink frame indicated by the network transfer information is, for example, a frame size of a frame from the wireless terminal to the central station. That is, in such a case, uplink indicates a direction from the wireless terminal to the central station in a propagation direction of a signal.

A communication device 900 in FIG. 1 is an example of one communication device, and a wireless terminal 901 in FIG. 1 is an example of the other communication device. Therefore, the communication device 900 may be, for example, a server, or may be, for example, a central station.

The communication control unit 102 executes adjustment processing on the basis of the network transfer information obtained by the other communication device. The adjustment processing is processing of reducing a waiting time until a frame is transmitted according to a predetermined rule determined in advance on the basis of the network transfer information.

The processing of reducing the waiting time until a frame is transmitted is, for example, processing of adjusting a frame transmission timing in time division duplex (TDD) according to a predetermined rule set in advance (hereinafter, referred to as “TDD timing adjustment processing”). The frame transmission timing is a timing at which a frame is transmitted. The processing of reducing a waiting time until a frame is transmitted may be, for example, processing of adjusting a transport block size (TBS) according to a predetermined rule set in advance (hereinafter, referred to as “TBS adjustment processing”).

The adjustment processing may be, for example, processing of adjusting both a frame transmission timing in TDD and a TBS according to a predetermined rule set in advance. Therefore, the adjustment processing is, for example, processing of performing one or both of the TDD timing adjustment processing and the TBS adjustment processing.

The waiting time until a frame is transmitted reduced by the adjustment processing is, for example, a waiting time for transmission of an uplink transmission frame. The uplink transmission frame is a frame propagated in the uplink direction and is a frame transmitted to a transmission destination such as a server or a central station. Therefore, in a case where a transmission destination is the server or the central station, the uplink transmission frame is a frame transmitted from the wireless terminal 901 to a communication device such as a server or a central station.

In a case where a waiting time until a frame is transmitted is a waiting time for an uplink transmission frame, the frame transmission timing is, for example, an uplink transmission timing. The uplink transmission timing is a timing at which an uplink transmission frame is transmitted.

Further, the communication control unit 102 transfers the acquired network transfer information to the transfer control unit 101. The transfer control unit 101 controls a frame transmission/reception timing on the basis of the network transfer information acquired from the communication control unit 102.

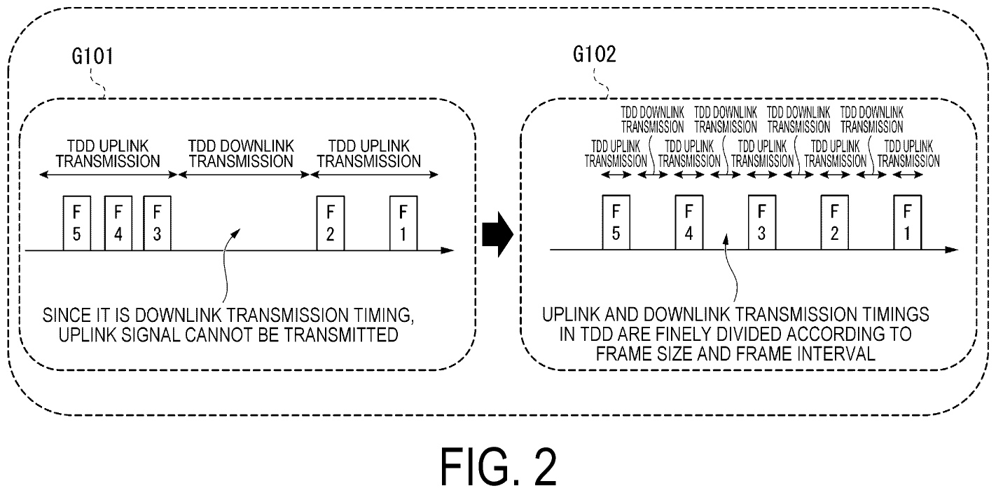

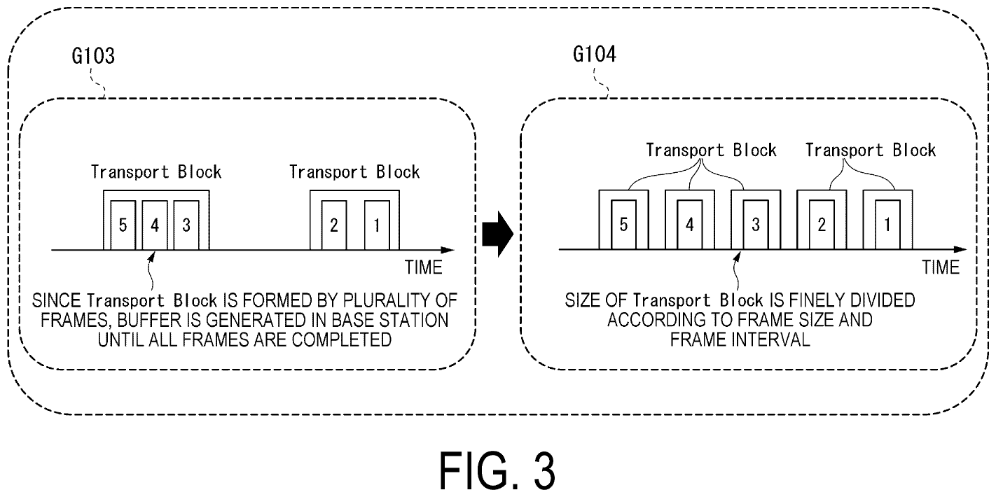

Effects obtained by the adjustment processing will be described with reference to FIGS. 2 and 3. Hereinafter, the effects of the adjustment processing will be described using a traffic flow from a wireless terminal to a base station as an example for easy understanding of the description. FIG. 2 is a first explanatory diagram for describing an effect of the adjustment processing in the embodiment. More specifically, FIG. 2 is a diagram for describing an effect of the TDD timing adjustment processing in the embodiment.

An image G101 in FIG. 2 illustrates an example of a state of a signal transmitted from the wireless terminal to the base station in a case where the adjustment processing is not performed. More specifically, the image G101 illustrates an example of a state of signal transmission in a case where the adjustment processing is not performed by using five frames F1 to F5. In the image G101, a period between the frame F2 and the frame F3 is a downlink transmission timing in TDD.

In a case where the adjustment processing is not performed, an uplink signal cannot be transmitted at this timing. As a result, as illustrated in the image G101, a time interval between the frame F1 and the frame F2, a time interval between the frame F2 and the frame F3, and a time interval between the frame F3 and the frame F4 are non-uniform. The non-uniformity of the frame interval is a factor of an increase in jitter.

An image G102 in FIG. 2 illustrates an example of a state of signal transmission from a wireless terminal to a base station in a case where the TDD timing adjustment processing is performed. More specifically, the image G102 illustrates an example of a state of signal transmission in a case where the TDD timing adjustment processing is performed by using five frames F1 to F5. As described above, the TDD timing adjustment processing is processing in which the communication control unit 102 performs adjustment so as to reduce a waiting time for a frame.

As an example of the TDD timing adjustment processing, the image G102 illustrates an example of a result of performing processing of more finely dividing uplink and downlink transmission timings in TDD than in the case of the image G101 on the basis of the frame size and the transmission interval of an uplink transmission frame. Note that finely dividing the transmission timings indicates, for example, setting a time interval of uplink transmission in TDD to an interval according to a frame size of an uplink transmission frame and setting a time interval of downlink transmission in TDD to an interval according to a transmission interval of an uplink transmission frame. Thus, in the example of the image G102, the frame intervals of uplink transmission frames are uniform. Therefore, in the example of the image G102, jitter is reduced.

FIG. 3 is a second explanatory diagram for describing an effect of the adjustment processing in the embodiment. More specifically, FIG. 3 is a diagram for describing an effect of the TBS adjustment processing in the embodiment.

An image G103 in FIG. 3 illustrates an example of a state of a signal transmitted from a wireless terminal to a base station in a case where the adjustment processing is not performed. More specifically, the image G103 illustrates an example of a state of signal transmission in a case where the adjustment processing is not performed by using five frames 1 to 5. In the example of the image G103, the frames 1 and 2 form one transport block.

In the example of the image G103, the frames 3 to 5 form another transport block different from the frames 1 and 2. Transport blocks each have different sizes because the numbers of frames included therein are different. In the example of the image G103, since a transport block is formed by a plurality of frames, a buffer is generated in the base station until all the frames are completed. As illustrated in the image G103, the frame intervals are not uniform in the example of the image G103. Therefore, this is a factor of an increase in jitter in the example of the image G103.

An image G104 in FIG. 3 illustrates an example of a state of signal transmission from a wireless terminal to a base station in a case where the TBS adjustment processing is performed. More specifically, the image G104 illustrates an example of a state of signal transmission in a case where the TBS adjustment processing is performed by using five frames 1 to 5. The image G104 illustrates an example of a result of performing, as the TBS adjustment processing, processing of more finely dividing a size of a transport block than in the case of the image G103 on the basis of a frame size and a frame interval. As a result, in the example of the image G104, each of the frames 1 to 5 forms one transport block. Therefore, in the example of the image G104, the frame intervals are uniform. Therefore, in the example of the image G104, jitter is reduced.

As described above, by the adjustment processing being executed, jitter is reduced.

Hereinafter, a first application example and a second application example of the signal transfer system 100 in the embodiment will be described.

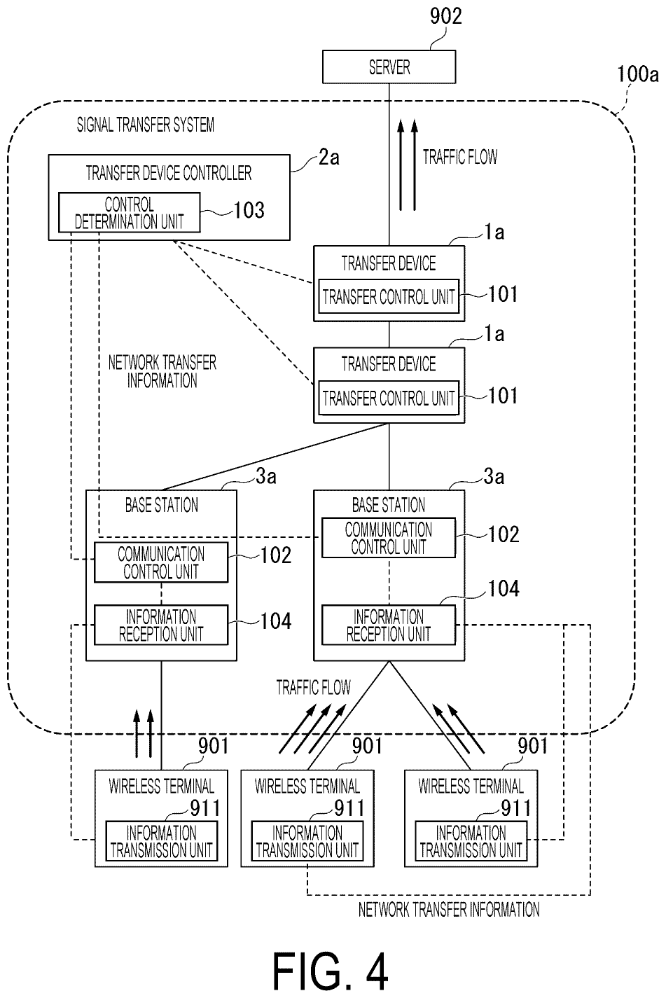

FIG. 4 is a diagram illustrating the first application example of the signal transfer system 100 in the embodiment. Hereinafter, the signal transfer system 100 in the first application example will be referred to as a signal transfer system 100a. The signal transfer system 100a transfers a signal from a wireless terminal 901 to a server 902 and transfers a signal from the server 902 to the wireless terminal 901. The server 902 is an example of the communication device 900. The signal transfer system 100a includes one or a plurality of transfer devices 1a, a transfer device controller 2a, and one or a plurality of base stations 3a. Both the wireless terminal 901 and the server 902 are devices that transmit and receive signals.

The transfer device 1a transfers a signal transmitted from a transfer source device to a transfer destination device. The transfer device controller 2a controls operation of each transfer device 1a included in the signal transfer system 100a. The transfer device controller 2a determines, for example, a transfer destination device to which each transfer device 1a transfers a signal. The base station 3a is a base station that communicates with the wireless terminal 901. The base station 3a transfers a signal received from the wireless terminal 901 to the transfer device 1a that is a transfer destination through communication with the wireless terminal 901, and transmits a signal transmitted from the transfer device 1a to the wireless terminal 901.

Each wireless terminal 901 includes an information transmission unit 911. The information transmission unit 911 included in the wireless terminal 901 extracts network transfer information for each traffic flow. The information transmission unit 911 transmits the extracted network transfer information to an information reception unit 104 of the base station 3a that faces (communicates with) its own device (wireless terminal 901).

The network transfer information is information regarding a traffic flow. The information regarding a traffic flow includes information indicating a frame size and a transmission interval of an uplink transmission frame. Therefore, the network transfer information includes information indicating a frame size and a transmission interval of an uplink transmission frame. The uplink transmission frame is a frame propagated in the uplink direction and is a frame transmitted from the wireless terminal 901 to the server 902. Note that the information regarding a traffic flow may indicate, for example, a transmission rate or a destination address. Therefore, the network transfer information may include, for example, information indicating a transmission rate or information indicating a destination address.

Each base station 3a includes a communication control unit 102 and an information reception unit 104. The information reception unit 104 included in the base station 3a receives network transfer information transmitted from the information transmission unit 911 of the wireless terminal 901 that faces (communicates with) its own device (base station 3a). The information reception unit 104 outputs the received network transfer information to the communication control unit 102 of its own device (base station 3a).

The communication control unit 102 of the base station 3a acquires the network transfer information output from the information reception unit 104 of its own device (base station 3a). The communication control unit 102 performs adjustment processing on the basis of the acquired network transfer information.

The adjustment processing is processing of reducing a waiting time until an uplink transmission frame is transmitted in the wireless terminal 901 according to a predetermined rule determined in advance on the basis of the network transfer information. The processing of reducing a waiting time until an uplink transmission frame is transmitted may be the TDD timing adjustment processing or the TBS adjustment processing. Alternatively, the adjustment processing may be both the TDD timing adjustment processing and the TBS adjustment processing. Therefore, the adjustment processing is processing of performing one or both of the TDD timing adjustment processing and the TBS adjustment processing.

The communication control unit 102 of the base station 3a sends back information indicating uplink transmission permission to the wireless terminal 901 (that has transmitted the network transfer information to its own device (base station 3a)) on the basis of the result of the adjustment processing. The information indicating the uplink transmission permission is information for instructing a timing at which the base station 3a transmits an uplink transmission frame to the wireless terminal 901. As a result, the transmission timing of the uplink transmission frame in the wireless terminal 901 is controlled, and the waiting time until the uplink transmission frame is transmitted in the wireless terminal 901 is reduced. As a result, jitter that occurs in uplink wireless transmission is reduced.

Furthermore, the communication control unit 102 of the base station 3a transfers the acquired network transfer information to the transfer device controller 2a.

The transfer device 1a in the example of FIG. 4 is installed in a section called backhaul (BH), for example.

Note that the base station 3a may be, for example, a Wi-Fi (registered trademark) access point. The signal transfer system 100a is not necessarily applied to a mobile communication system, and may be applied to a wireless communication system other than the mobile communication system.

The transfer device controller 2a includes a control determination unit 103. The control determination unit 103 receives the network transfer information transmitted from each base station 3a. The control determination unit 103 determines a transmission/reception timing of an uplink transmission frame in each transfer device 1a on the basis of the received network transfer information. The control determination unit 103 transmits instruction information indicating an instruction for causing the transfer device 1a to transmit/receive the uplink transmission frame at the determined transmission/reception timing of the uplink transmission frame to each transfer device 1a.

The transmission/reception timing of the uplink transmission frame is determined on the basis of, for example, bandwidth allocation by dynamic bandwidth allocation (DBA) of a passive optical network (PON), a gate opening/closing timing of an 802.1Qbv Time Aware Shaper described in Non Patent Literature 3, or the like.

Each transfer device 1a includes a transfer control unit 101. The transfer control unit 101 of the transfer device 1a receives the instruction information transmitted from the control determination unit 103 of the transfer device controller 2a. In accordance with the received instruction information, the transfer control unit 101 performs signal transfer control so as to transmit/receive the uplink transmission frame at the transmission/reception timing of the uplink transmission frame determined by the control determination unit 103 of the transfer device controller 2a. As a result, for example, a waiting time in the transfer device 1a until the uplink transmission frame is transmitted at the time of congestion is reduced, and jitter that occurs in uplink wireless transmission is reduced.

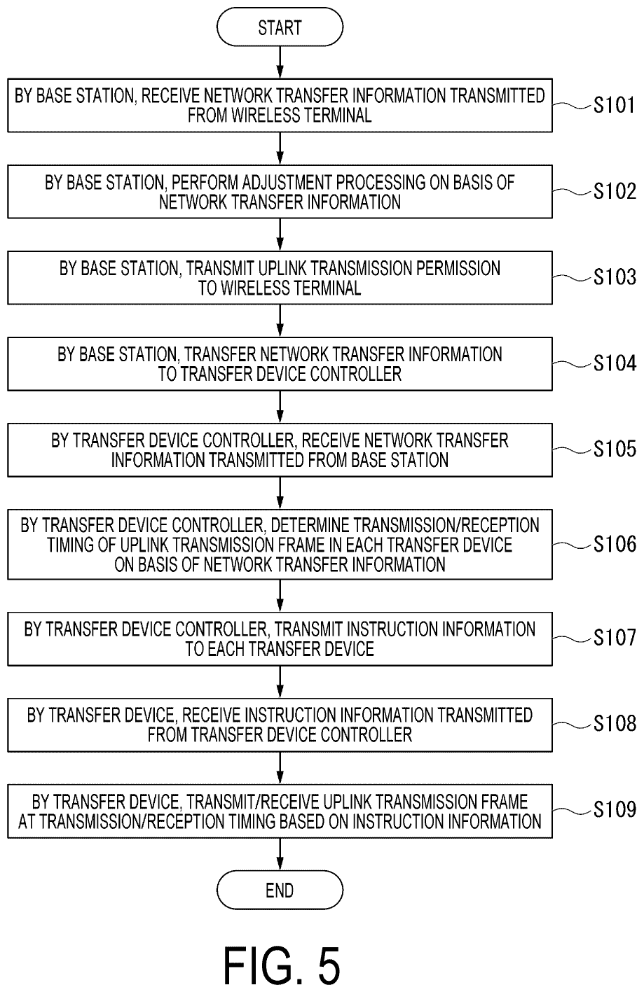

FIG. 5 is a flowchart illustrating an example of a flow of processing executed by the signal transfer system 100a according to the embodiment. More specifically, an example of a flow of processing executed by the signal transfer system 100a in a case where a signal is transmitted from the wireless terminal 901 to the server 902 will be described. In the signal transfer system 100a, the processing illustrated in FIG. 5 is repeatedly performed.

The information reception unit 104 included in each base station 3a receives network transfer information transmitted from the wireless terminal 901 that faces its own device (base station 3a) (step S101). The information reception unit 104 outputs the received network transfer information to the communication control unit 102 of its own device (base station 3a). The communication control unit 102 acquires the network transfer information output from the information reception unit 104. The communication control unit 102 performs adjustment processing on the basis of the acquired network transfer information (step S102). The adjustment processing is processing of performing one or both of the TDD timing adjustment processing and the TBS adjustment processing.

The communication control unit 102 of the base station 3a sends back information indicating uplink transmission permission to the wireless terminal 901 (that has transmitted the network transfer information to its own device (base station 3a)) on the basis of the result of the adjustment processing (step S103). Furthermore, the communication control unit 102 transfers the acquired network transfer information to the transfer device controller 2a (step S104).

The control determination unit 103 of the transfer device controller 2a receives the network transfer information transmitted from each base station 3a (step S105). The control determination unit 103 determines a transmission/reception timing of an uplink transmission frame in each transfer device 1a on the basis of the received network transfer information (step S106). The control determination unit 103 transmits instruction information indicating an instruction for transmitting/receiving the uplink transmission frame at the determined transmission/reception timing of the uplink transmission frame to each transfer device 1a (step S107).

The transfer control unit 101 of each transfer device 1a receives the instruction information transmitted from the control determination unit 103 of the transfer device controller 2a (step S108). In accordance with the received instruction information, the transfer control unit 101 of each transfer device 1a performs transfer control so as to transmit/receive the uplink transmission frame at the transmission/reception timing of the uplink transmission frame determined by the control determination unit 103 of the transfer device controller 2a (step S109). Thus, the processing executed by the signal transfer system 100a illustrated in the flowchart of FIG. 5 ends.

As described above, according to the first application example of the signal transfer system 100 in the embodiment, first, the network transfer information is transmitted from each wireless terminal 901 to the base station 3a. As a result, for each traffic flow, each wireless terminal 901 notifies the base station 3a of information indicating at least one of the frame size or the transmission interval of the uplink transmission frame transmitted from a function of an application layer in each wireless terminal 901.

Each base station 3a performs adjustment processing of adjusting at least one of the uplink transmission timing in TDD or the TBS on the basis of the information of which notification is given from the wireless terminal 901. Each base station 3a sends back information indicating uplink transmission permission to the wireless terminal 901 on the basis of the result of the adjustment processing. As a result, the transmission timing of the uplink transmission frame in the wireless terminal 901 is controlled, and the waiting time until the uplink transmission frame is transmitted in the wireless terminal 901 is reduced. As a result, jitter that occurs in uplink wireless transmission is reduced.

Furthermore, each base station 3a transfers the acquired network transfer information to the transfer device controller 2a. The transfer device controller 2a receives the network transfer information transmitted from each base station 3a. The transfer device controller 2a determines a transmission/reception timing of an uplink transmission frame in each transfer device 1a on the basis of the received network transfer information. The transfer device controller 2a controls each transfer device 1a so that the uplink transmission frame is transferred at the determined transmission/reception timing of the uplink transmission frame. As a result, a waiting time in the transfer device 1a until the uplink transmission frame is transmitted at the time of congestion is reduced, and jitter that occurs in uplink wireless transmission is reduced.

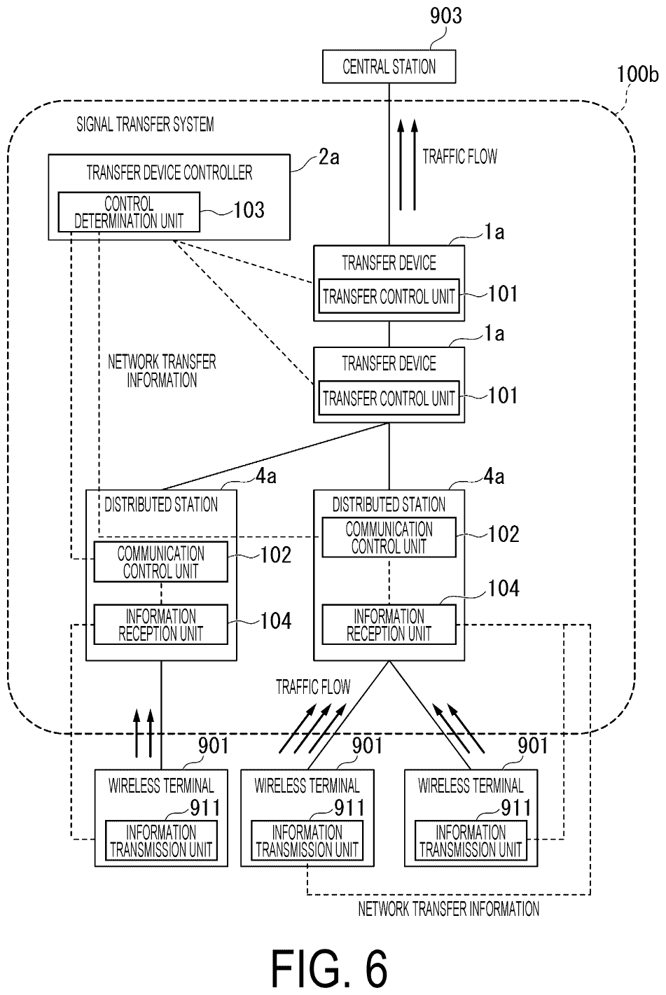

FIG. 6 is a diagram illustrating a second application example of the signal transfer system 100 according to the embodiment. Hereinafter, the signal transfer system 100 in the second application example will be referred to as a signal transfer system 100b. The signal transfer system 100b transfers a signal from the wireless terminal 901 to the central station 903 and transfers a signal from the central station 903 to the wireless terminal 901. The central station 903 is an example of the communication device 900. The signal transfer system 100b is different from the signal transfer system 100a according to the above-described first application in including a distributed station 4a instead of the base station 3a. The central station 903 is a central station that transmits and receives signals.

The distributed station 4a is a distributed station that communicates with the wireless terminal 901. The distributed station 4a transfers a signal received from the wireless terminal 901 to the transfer device 1a that is a transfer destination through communication with the wireless terminal 901, and transmits a signal transmitted from the transfer device 1a to the wireless terminal 901.

Each distributed station 4a includes a communication control unit 102 and an information reception unit 104. The information reception unit 104 included in the distributed station 4a receives network transfer information transmitted from the information transmission unit 911 of the wireless terminal 901 that faces its own device (distributed station 4a). The information reception unit 104 outputs the received network transfer information to the communication control unit 102 of its own device (distributed station 4a).

The communication control unit 102 of the distributed station 4a acquires the network transfer information output from the information reception unit 104 of its own device (distributed station 4a). The communication control unit 102 performs adjustment processing on the basis of the acquired network transfer information. The adjustment processing is processing of performing one or both of the TDD timing adjustment processing and the TBS adjustment processing.

The communication control unit 102 of the distributed station 4a sends back information indicating uplink transmission permission to the wireless terminal 901 (that has transmitted the network transfer information to its own device (distributed station 4a)) on the basis of the result of the adjustment processing. As a result, the transmission timing of the uplink transmission frame in the wireless terminal 901 is controlled, and the waiting time until the uplink transmission frame is transmitted in the wireless terminal 901 is reduced. As a result, jitter that occurs in uplink wireless transmission is reduced.

Furthermore, the communication control unit 102 of the distributed station 4a transfers the acquired network transfer information to the transfer device controller 2a. Note that the central station 903 and the distributed station 4a in the example in FIG. 6 are, for example, a central unit (CU) and a distributed unit (DU) in a mobile communication system. The transfer device 1a in the example in FIG. 6 is installed in a section called mobile midhaul (MMH), for example.

The central station 903 may be a DU, and the distributed station 4a may be a radio unit (RU). In such a case, the transfer device 1a may be installed in a section called mobile fronthaul (MFH), for example.

The central station 903 may also be a Wi-Fi (registered trademark) controller, and the distributed station 4a may be a Wi-Fi (registered trademark) access point. The signal transfer system 100b is not necessarily applied to a mobile communication system, and may be applied to a wireless communication system other than the mobile communication system.

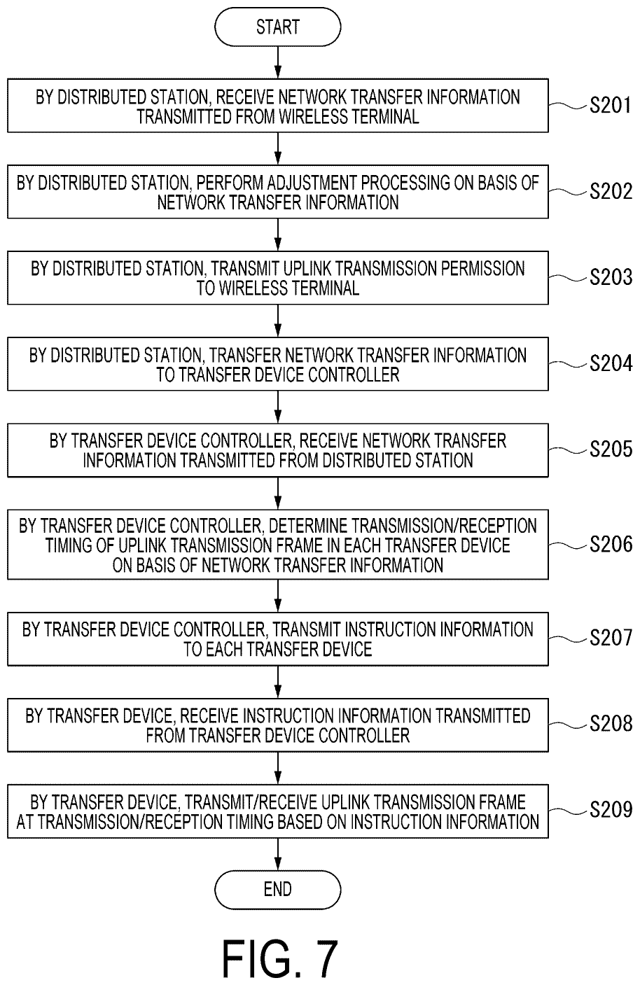

FIG. 7 is a flowchart illustrating an example of a flow of processing executed by the signal transfer system 100b according to the embodiment. More specifically, an example of a flow of processing executed by the signal transfer system 100b in a case where a signal is transmitted from the wireless terminal 901 to the central station 903 will be described. In the signal transfer system 100b, the processing illustrated in FIG. 7 is repeatedly performed.

The information reception unit 104 included in each distributed station 4a receives network transfer information transmitted from the wireless terminal 901 that faces its own device (distributed station 4a) (step S201). The information reception unit 104 outputs the received network transfer information to the communication control unit 102 of its own device (distributed station 4a). The communication control unit 102 acquires the network transfer information output from the information reception unit 104. The communication control unit 102 performs adjustment processing on the basis of the acquired network transfer information (step S202). The adjustment processing is processing of performing one or both of the TDD timing adjustment processing and the TBS adjustment processing.

The communication control unit 102 of the distributed station 4a sends back information indicating uplink transmission permission to the wireless terminal 901 (that has transmitted the network transfer information to its own device (distributed station 4a)) on the basis of the result of the adjustment processing (step S203). Furthermore, the communication control unit 102 transfers the acquired network transfer information to the transfer device controller 2a (step S204).

The control determination unit 103 of the transfer device controller 2a receives the network transfer information transmitted from each distributed station 4a (step S205). The control determination unit 103 determines a transmission/reception timing of an uplink transmission frame in each transfer device 1a on the basis of the received network transfer information (step S206). The control determination unit 103 transmits instruction information indicating an instruction for transmitting/receiving the uplink transmission frame at the determined transmission/reception timing of the uplink transmission frame to each transfer device 1a (step S207).

The transfer control unit 101 of each transfer device 1a receives the instruction information transmitted from the control determination unit 103 of the transfer device controller 2a (step S208). In accordance with the received instruction information, the transfer control unit 101 of each transfer device 1a performs transfer control so as to transmit/receive the uplink transmission frame at the transmission/reception timing of the uplink transmission frame determined by the control determination unit 103 of the transfer device controller 2a (step S209). Thus, the processing executed by the signal transfer system 100b illustrated in the flowchart of FIG. 7 ends.

As described above, according to the first application example of the signal transfer system 100 in the embodiment, first, the network transfer information is transmitted from each wireless terminal 901 to the distributed station 4a. As a result, for each traffic flow, each wireless terminal 901 notifies the distributed station 4a of information indicating at least one of the frame size or the transmission interval of the uplink transmission frame transmitted from a function of an application layer in each wireless terminal 901.

Each distributed station 4a performs adjustment processing of adjusting at least one of the uplink transmission timing in TDD or the TBS on the basis of the information of which notification is given from the wireless terminal 901. Each distributed station 4a sends back information indicating uplink transmission permission to the wireless terminal 901 on the basis of the result of the adjustment processing. As a result, the transmission timing of the uplink transmission frame in the wireless terminal 901 is controlled, and the waiting time until the uplink transmission frame is transmitted in the wireless terminal 901 is reduced. As a result, jitter that occurs in uplink wireless transmission is reduced.

Furthermore, each distributed station 4a transfers the acquired network transfer information to the transfer device controller 2a. The transfer device controller 2a receives the network transfer information transmitted from each distributed station 4a. The transfer device controller 2a determines a transmission/reception timing of an uplink transmission frame in each transfer device 1a on the basis of the received network transfer information. The transfer device controller 2a controls each transfer device 1a so that the uplink transmission frame is transferred at the determined transmission/reception timing of the uplink transmission frame. As a result, a waiting time in the transfer device 1a until the uplink transmission frame is transmitted at the time of congestion is reduced, and jitter that occurs in uplink wireless transmission is reduced.

### <Example of Hardware Configuration of Each Device Included in System>

### <Transfer Device>

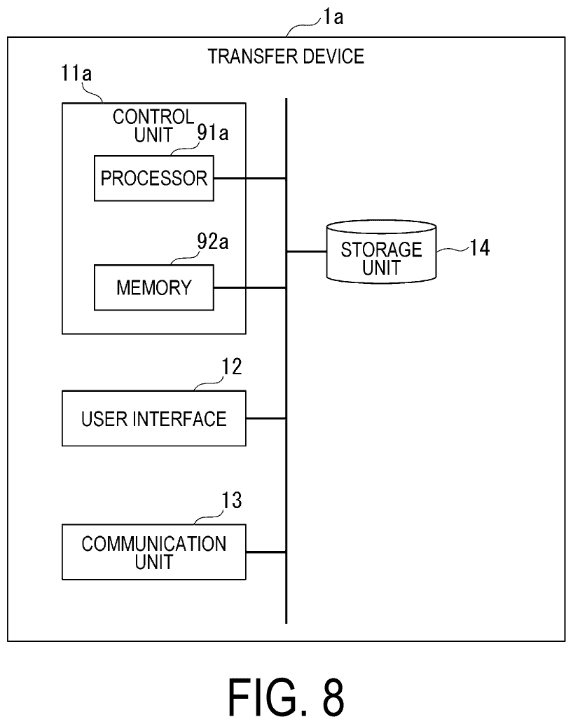

FIG. 8 is a diagram illustrating an example of a hardware configuration of the transfer device 1a (first transfer device) according to the embodiment. The transfer device 1a includes a control unit 11a including a processor 91a such as a central processing unit (CPU) and a memory 92a connected via a bus, and executes a program. The transfer device 1a functions as a device including the control unit 11a, a user interface 12, a communication unit 13, and a storage unit 14 by executing the program. More specifically, in the transfer device 1a, the processor 91a reads the program stored in the storage unit 14, and stores the read program in the memory 92a. When the processor 91a executes the program stored in the memory 92a, the transfer device 1a functions as a device including the control unit Hla, the user interface 12, the communication unit 13, and the storage unit 14.

The control unit 11a controls operation of various functional units included in the transfer device 1a. The user interface 12 includes an input device such as a mouse, a keyboard, or a touch panel. The user interface 12 may include an interface that connects such an input device to the transfer device 1a.

The user interface 12 includes a display device such as a cathode ray tube (CRT) display, a liquid crystal display, or an organic electro-luminescence (EL) display. The user interface 12 may include an interface that connects such a display device to the transfer device 1a.

The communication unit 13 includes an interface that connects the transfer device 1a to an external device. The communication unit 13 communicates with an external device in a wired or wireless manner. The external device is, for example, a signal transmission source device. The communication unit 13 receives a signal through communication with a signal transmission source device. The external device is, for example, a signal transfer destination device. The communication unit 13 transfers a signal to a signal transfer destination through communication with a signal transfer destination device. The communication unit 13, for example, receives instruction information transmitted from the control determination unit 103 of the transfer device controller 2a.

The storage unit 14 is configured by using a computer-readable storage medium device such as a magnetic hard disk device or a semiconductor storage device. The storage unit 14 stores various types of information regarding the transfer device 1a. The storage unit 14 stores, for example, various types of information generated as a result of processing executed by the control unit 11a.

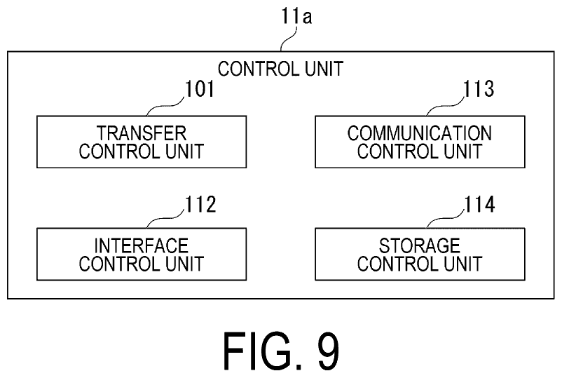

FIG. 9 is a diagram illustrating an example of a configuration of the control unit 11a included in the transfer device 1a according to the embodiment. The control unit 11a includes a transfer control unit 101, an interface control unit 112, a communication control unit 113, and a storage control unit 114. In accordance with instruction information received by the communication unit 13, the transfer control unit 101 performs signal transfer control so as to transmit/receive an uplink transmission frame at a transmission/reception timing of the uplink transmission frame determined by the control determination unit 103 of the transfer device controller 2a. The interface control unit 112 controls operation of the user interface 12. The communication control unit 113 controls operation of the communication unit 13. The storage control unit 114 controls operation of the storage unit 14.

### <Transfer Device Controller>

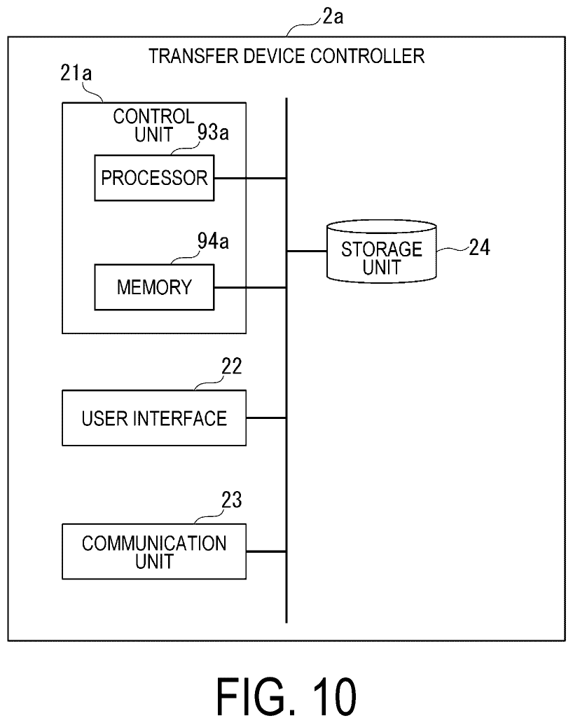

FIG. 10 is a diagram illustrating an example of a hardware configuration of the transfer device controller 2a (first transfer device controller) according to the embodiment. The transfer device controller 2a includes a control unit 21a including a processor 93a such as a CPU and a memory 94a connected via a bus, and executes a program. The transfer device controller 2a functions as a device including the control unit 21a, a user interface 22, a communication unit 23, and a storage unit 24 by executing the program.

More specifically, in the transfer device controller 2a, the processor 93a reads the program stored in the storage unit 24, and stores the read program in the memory 94a. When the processor 93a executes the program stored in the memory 94a, the transfer device controller 2a functions as a device including the control unit 21a, the user interface 22, the communication unit 23, and the storage unit 24.

The control unit 21a controls operation of various functional units included in the transfer device controller 2a. The user interface 22 includes an input device such as a mouse, a keyboard, or a touch panel. The user interface 22 may include an interface that connects such an input device to the transfer device controller 2a.

The user interface 22 includes a display device such as a CRT display, a liquid crystal display, or an organic EL display. The user interface 22 may include an interface that connects such a display device to the transfer device controller 2a.

The communication unit 23 includes an interface that connects the transfer device controller 2a to an external device. The communication unit 23 communicates with an external device in a wired or wireless manner. The external device is, for example, the transfer device 1a. The external device is, for example, the base station 3a or the distributed station 4a. The communication unit 23 acquires, for example, network transfer information. The communication unit 23 transfers, for example, the network transfer information to a predetermined transfer destination such as the communication control unit 102.

The storage unit 24 is configured by using a computer-readable storage medium device such as a magnetic hard disk device or a semiconductor storage device. The storage unit 24 stores various types of information regarding the transfer device controller 2a. The storage unit 24 stores, for example, various types of information generated as a result of processing executed by the control unit 21a.

FIG. 1l is a diagram illustrating an example of a configuration of the control unit 21a included in the transfer device controller 2a according to the embodiment. The control unit 21a includes a control determination unit 103, an interface control unit 212, a communication control unit 213, and a storage control unit 214. The control determination unit 103 determines a transmission/reception timing of an uplink transmission frame in each transfer device 1a on the basis of network transfer information acquired from each base station 3a. The control determination unit 103 transmits instruction information for causing the transfer device 1a to transmit/receive the uplink transmission frame at the determined transmission/reception timing of the uplink transmission frame to each transfer device 1a. The interface control unit 212 controls operation of the user interface 22. The communication control unit 213 controls operation of the communication unit 23. The storage control unit 214 controls operation of the storage unit 24.

### <Base Station>

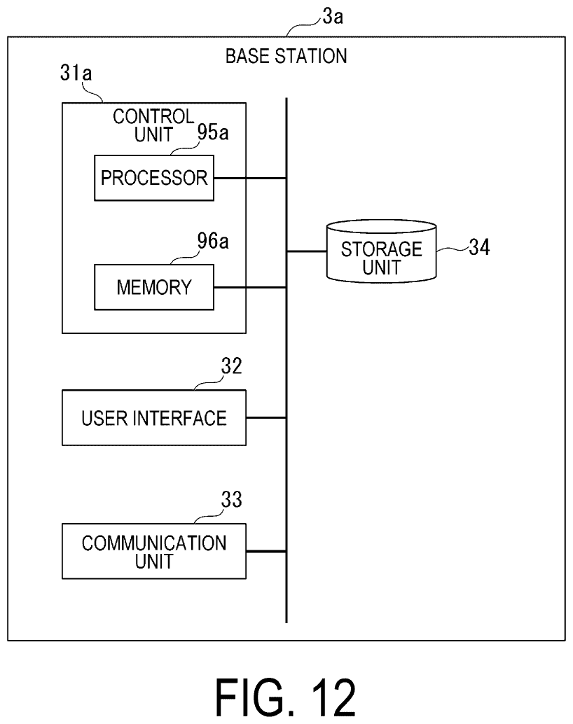

FIG. 12 is a diagram illustrating an example of a hardware configuration of the base station 3a (first base station) in the embodiment. The base station 3a includes a control unit 31a including a processor 95a such as a CPU and a memory 96a connected via a bus, and executes a program. The base station 3a functions as a device including the control unit 31a, a user interface 32, a communication unit 33, and a storage unit 34 by executing the program.

More specifically, in the base station 3a, the processor 95a reads the program stored in the storage unit 34, and stores the read program in the memory 96a. When the processor 95a executes the program stored in the memory 96a, the base station 3a functions as a device including the control unit 31a, the user interface 32, the communication unit 33, and the storage unit 34.

The control unit 31a controls operation of various functional units included in the base station 3a. The user interface 32 includes an input device such as a mouse, a keyboard, or a touch panel. The user interface 32 may include an interface that connects such an input device to the base station 3a.

The user interface 32 includes a display device such as a CRT display, a liquid crystal display, or an organic EL display. The user interface 32 may include an interface that connects such a display device to the base station 3a.

The communication unit 33 includes an interface that connects the base station 3a to an external device. The communication unit 33 communicates with an external device in a wired or wireless manner. The external device is, for example, the transfer device 1a. The external device is, for example, the wireless terminal 901. Operation of the communication unit 33 is controlled by the communication control unit 102. The communication unit 33 acquires network transfer information through communication with, for example, the information reception unit 104, the wireless terminal 901, and the information transmission unit 911.

The storage unit 34 is configured by using a computer-readable storage medium device such as a magnetic hard disk device or a semiconductor storage device. The storage unit 34 stores various types of information regarding the base station 3a. The storage unit 34 stores, for example, various types of information generated as a result of processing executed by the control unit 31a.

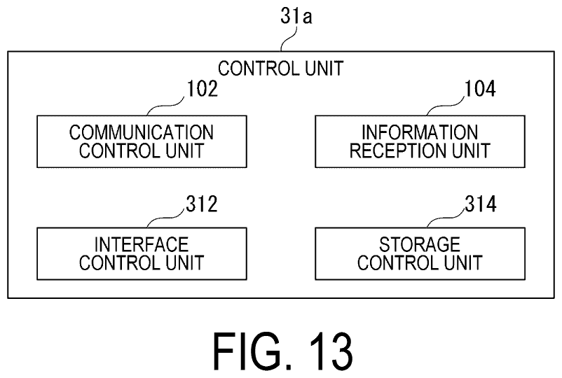

FIG. 13 is a diagram illustrating an example of a configuration of the control unit 31a included in the base station 3a according to the embodiment. The control unit 31a includes a communication control unit 102, an information reception unit 104, an interface control unit 312, and a storage control unit 314. The communication control unit 102 performs adjustment processing on the basis of network transfer information input from the information reception unit 104. The communication control unit 102 sends back information indicating uplink transmission permission to the wireless terminal 901 on the basis of the result of the adjustment processing. Furthermore, the communication control unit 102 transfers the acquired network transfer information to the transfer device controller 2a. The information reception unit 104 outputs the network transfer information received from the information transmission unit 911 of the wireless terminal 901 to the communication control unit 102. The interface control unit 312 controls operation of the user interface 32. The storage control unit 314 controls operation of the storage unit 24.

### <Distributed Station>

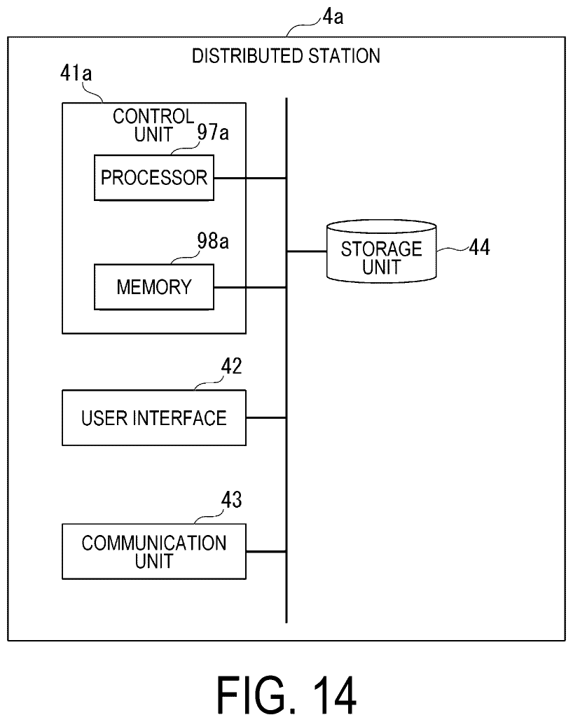

FIG. 14 is a diagram illustrating an example of a hardware configuration of the distributed station 4a (first distributed station) according to the embodiment. The distributed station 4a includes a control unit 41a including a processor 97a such as a CPU and a memory 98a connected via a bus, and executes a program. The distributed station 4a functions as a device including the control unit 41a, a user interface 42, a communication unit 43, and a storage unit 44 by executing a program.

More specifically, in the distributed station 4a, the processor 97a reads the program stored in the storage unit 44, and stores the read program in the memory 98a. When the processor 97a executes the program stored in the memory 98a, the distributed station 4a functions as a device including the control unit 41a, the user interface 42, the communication unit 43, and the storage unit 44.

The control unit 41a controls operation of various functional units included in the distributed station 4a. The user interface 42 includes an input device such as a mouse, a keyboard, or a touch panel. The user interface 42 may include an interface that connects such an input device to the distributed station 4a.

The user interface 42 includes a display device such as a CRT display, a liquid crystal display, or an organic EL display. The user interface 42 may include an interface that connects such a display device to the distributed station 4a.

The communication unit 43 includes an interface that connects the distributed station 4a to an external device. The communication unit 43 communicates with an external device in a wired or wireless manner. The external device is, for example, the transfer device 1a. The external device is, for example, the wireless terminal 901. Operation of the communication unit 43 is controlled by the communication control unit 102. The communication unit 43 acquires network transfer information through communication with, for example, the information reception unit 104, the wireless terminal 901, and the information transmission unit 911.

The storage unit 44 is configured by using a computer-readable storage medium device such as a magnetic hard disk device or a semiconductor storage device. The storage unit 44 stores various types of information regarding the distributed station 4a. The storage unit 44 stores, for example, various types of information generated as a result of processing executed by the control unit 41a.

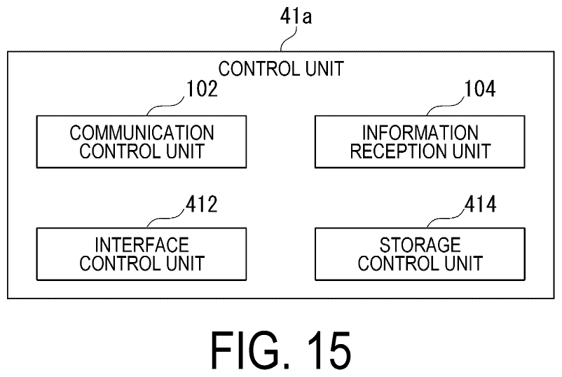

FIG. 15 is a diagram illustrating an example of a configuration of the control unit 41a included in the distributed station 4a according to the embodiment. The control unit 41a includes a communication control unit 102, an information reception unit 104, an interface control unit 412, and a storage control unit 414. The communication control unit 102 performs adjustment processing on the basis of network transfer information input from the information reception unit 104. The communication control unit 102 sends back information indicating uplink transmission permission to the wireless terminal 901 on the basis of the result of the adjustment processing. Furthermore, the communication control unit 102 transfers the acquired network transfer information to the transfer device controller 2a. The information reception unit 104 outputs the network transfer information received from the information transmission unit 911 of the wireless terminal 901 to the communication control unit 102. The interface control unit 412 controls operation of the user interface 42. The storage control unit 414 controls operation of the storage unit 44.

### <Wireless Terminal>

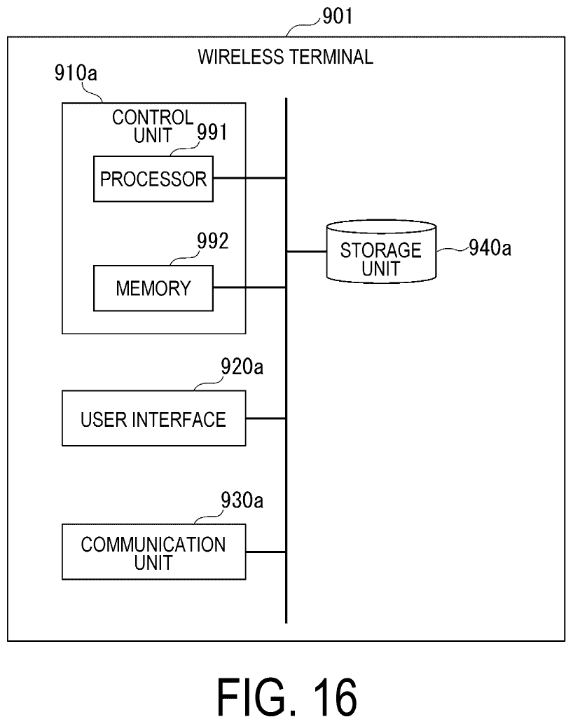

FIG. 16 is a diagram illustrating an example of a hardware configuration of the wireless terminal 901 according to the embodiment. The wireless terminal 901 includes a control unit 910a including a processor 991 such as a CPU and a memory 992 connected via a bus, and executes a program. The wireless terminal 901 functions as a device including the control unit 910a, a user interface 920a, a communication unit 930a, and a storage unit 940a by executing a program.

More specifically, in the wireless terminal 901, the processor 991 reads the program stored in the storage unit 940a, and stores the read program in the memory 992. When the processor 991 executes the program stored in the memory 992, the wireless terminal 901 functions as a device including the control unit 910a, the user interface 920a, the communication unit 930a, and the storage unit 940a.

The control unit 910a controls operation of various functional units included in the wireless terminal 901. The user interface 920a includes an input device such as a mouse, a keyboard, or a touch panel. The user interface 920a may include an interface that connects such an input device to the wireless terminal 901.

The user interface 920a includes a display device such as a CRT display, a liquid crystal display, or an organic EL display. The user interface 920a may include an interface that connects such a display device to the wireless terminal 901.

The communication unit 930a includes an interface that connects the wireless terminal 901 to an external device. The communication unit 930a communicates with an external device in a wired or wireless manner. The external device is, for example, the base station 3a or the distributed station 4a.

The storage unit 940a is configured by using a computer-readable storage medium device such as a magnetic hard disk device or a semiconductor storage device. The storage unit 940a stores various types of information regarding the wireless terminal 901. The storage unit 940a stores, for example, various types of information generated as a result of processing executed by the control unit 910a.

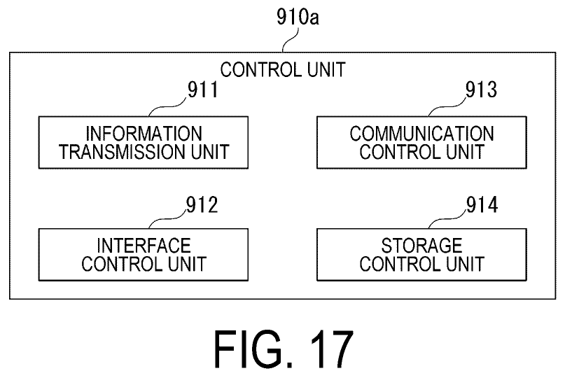

FIG. 17 is a diagram illustrating an example of a configuration of the control unit 910a included in the wireless terminal 901 according to the embodiment. The wireless terminal 901 includes an information transmission unit 911, an interface control unit 912, a communication control unit 913, and a storage control unit 914. The information transmission unit 911 transmits network transfer information extracted for each traffic flow to the information reception unit 104 of the base station 3a. The interface control unit 912 controls operation of the user interface 920. The communication control unit 913 controls operation of the communication unit 930. The storage control unit 914 controls operation of the storage unit 940.

### <Communication Device Such as Server or Central Station>

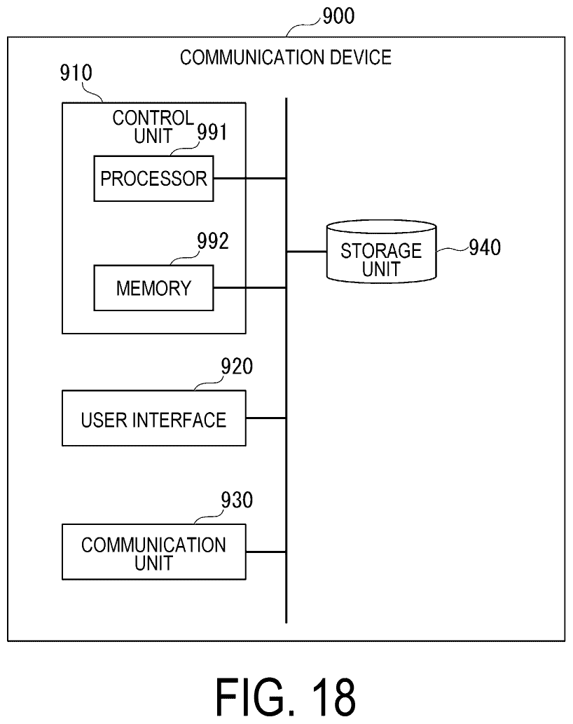

FIG. 18 is a diagram illustrating an example of a hardware configuration of the communication device 900 according to the embodiment. The communication device 900 includes a control unit 910 including a processor 991 such as a CPU and a memory 992 connected via a bus, and executes a program. The communication device 900 functions as a device including the control unit 910, a user interface 920, a communication unit 930, and a storage unit 940 by executing the program.

More specifically, in the communication device 900, the processor 991 reads the program stored in the storage unit 940, and stores the read program in the memory 992. When the processor 991 executes the program stored in the memory 992, the communication device 900 functions as a device including the control unit 910, the user interface 920, the communication unit 930, and the storage unit 940.

The control unit 910 controls operation of various functional units included in the communication device 900. The user interface 920 includes an input device such as a mouse, a keyboard, or a touch panel. The user interface 920 may include an interface that connects such an input device to the communication device 900.

The user interface 920 includes a display device such as a CRT display, a liquid crystal display, or an organic EL display. The user interface 920 may include an interface that connects such a display device to the communication device 900.

The communication unit 930 includes an interface that connects the communication device 900 to an external device. The communication unit 930 communicates with an external device in a wired or wireless manner. The external device is, for example, the transfer device 1a.

The storage unit 940 is configured by using a computer-readable storage medium device such as a magnetic hard disk device or a semiconductor storage device. The storage unit 940 stores various types of information regarding the communication device 900. The storage unit 940 stores, for example, various types of information generated as a result of processing executed by the control unit 910.

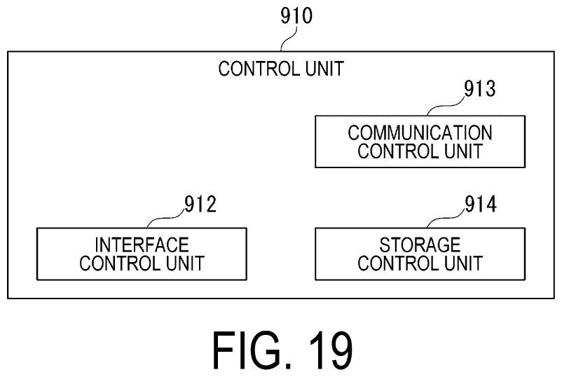

FIG. 19 is a diagram illustrating an example of a configuration of the control unit 910 included in the communication device 900 according to the embodiment. The communication device 900 includes an interface control unit 912, a communication control unit 913, and a storage control unit 914. The interface control unit 912 controls operation of the user interface 920. The communication control unit 913 controls operation of the communication unit 930. The storage control unit 914 controls operation of the storage unit 940.

### First Modification

Note that the control determination unit 103 of the transfer device controller 2a may execute processing of analysis (hereinafter, referred to as “analysis processing”) based on network transfer information acquired from the communication control units 102 of a plurality of base stations 3a or a plurality of distributed stations 4a. The analysis processing includes, for example, processing of averaging values related to a state of a frame such as a frame size and a transmission interval of an uplink transmission frame based on network transfer information acquired from the communication control units 102 of the plurality of base stations 3a or the plurality of distributed stations 4 a.

The analysis processing may include, for example, processing of predicting a future state of a frame such as a frame size and a transmission interval of an uplink transmission frame in the future on the basis of values related to a state of a frame such as a frame size and a transmission interval of an uplink transmission frame based on network transfer information acquired from the communication control units 102 of the plurality of base stations 3a or the plurality of distributed stations 4a. A result of the analysis processing is used for, for example, adjustment processing on future communication, and an effect in which a waiting time can be reduced even for an uplink transmission frame for which network transfer information has not been transferred to the communication control unit 102 of the base station 3a or the distributed station 4a is achieved.

### Second Modification

Hereinafter, a first application example and a second application example of the signal transfer system 100 in a second modification of the embodiment will be described.

As the first application example of the second modification, the signal transfer system 100a may further include a wireless controller 5. The wireless controller 5 controls operation of the base station 3a. Hereinafter, the signal transfer system 100 including the wireless controller 5 will be described. Hereinafter, the signal transfer system 100a including the wireless controller 5 will be referred to as a signal transfer system 100c.

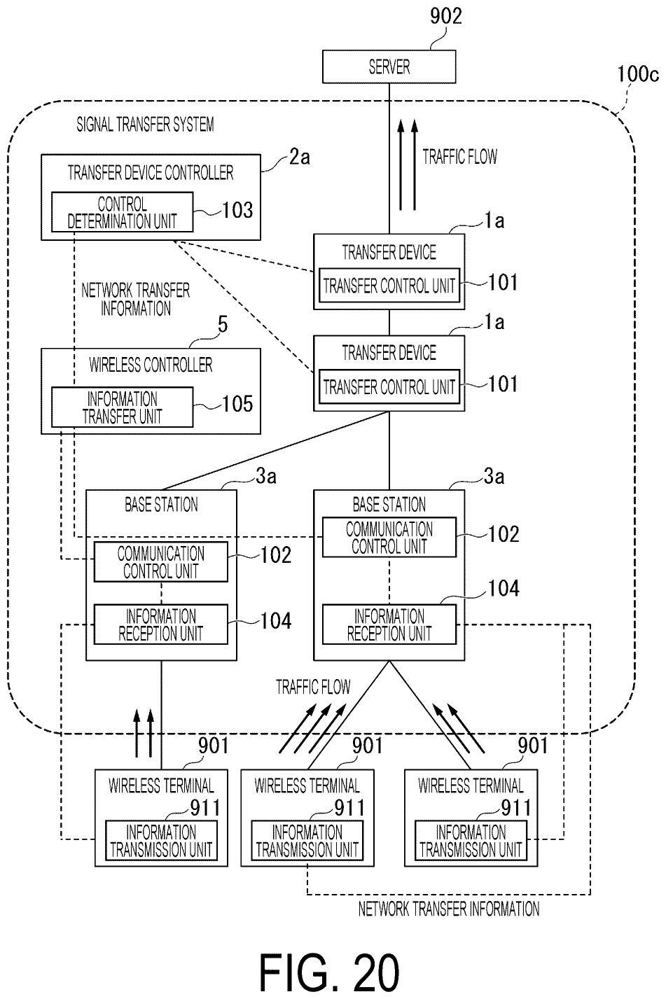

FIG. 20 is a block diagram illustrating the first application example of the signal transfer system according to the second modification of the embodiment. The signal transfer system 100c is different from the signal transfer system 100a in including the wireless controller 5. The wireless controller 5 controls operation of the base station 3a. The wireless controller 5 includes an information transfer unit 105. The information transfer unit 105 included in the wireless controller 5 receives network transfer information transmitted from the communication control unit 102 included in the base station 3a. The information transfer unit 105 included in the wireless controller 5 transfers the received network transfer information to the control determination unit 103 of the transfer device controller 2a.

As described above, the control determination unit 103 of the transfer device controller 2a may acquire the network transfer information not directly from the communication control unit 102 of the base station 3a but via the information transfer unit 105 included in the wireless controller 5.

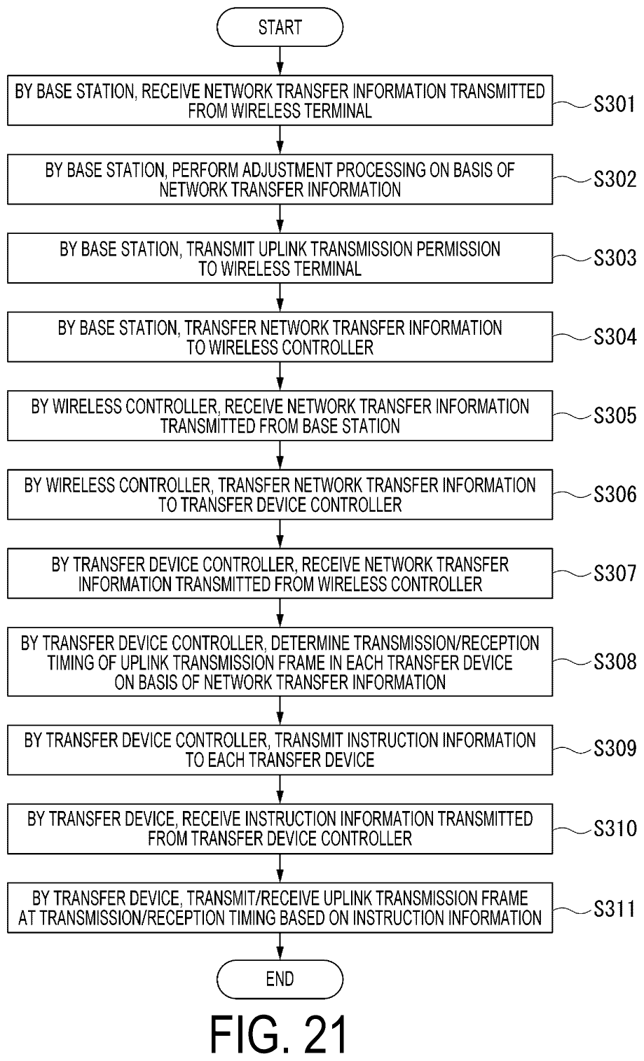

FIG. 21 is a flowchart illustrating an example of a flow of processing executed by the signal transfer system 100c according to the first application example of the second modification. More specifically, an example of a flow of processing executed by the signal transfer system 100c in a case where a signal is transmitted from the wireless terminal 901 to the server 902 will be described. In the signal transfer system 100c, the processing illustrated in FIG. 21 is repeatedly performed.

The information reception unit 104 included in each base station 3a receives network transfer information transmitted from the wireless terminal 901 that faces its own device (base station 3a) (step S301). The information reception unit 104 outputs the received network transfer information to the communication control unit 102 of its own device (base station 3a). The communication control unit 102 acquires the network transfer information output from the information reception unit 104. The communication control unit 102 performs adjustment processing on the basis of the acquired network transfer information (step S302). The adjustment processing is processing of performing one or both of the TDD timing adjustment processing and the TBS adjustment processing.

The communication control unit 102 of the base station 3a sends back information indicating uplink transmission permission to the wireless terminal 901 (that has transmitted the network transfer information to its own device (base station 3a)) on the basis of the result of the adjustment processing (step S303). Furthermore, the communication control unit 102 transfers the acquired network transfer information to the wireless controller 5 (step S304).

The information transfer unit 105 of the wireless controller 5 receives the network transfer information transmitted from each base station 3a (step S305). The communication control unit 102 transfers the acquired network transfer information to the transfer device controller 2a (step S306).

The control determination unit 103 of the transfer device controller 2a receives the network transfer information transmitted from the wireless controller 5 (step S307).

Subsequent processing in steps S308 and S309 by the control determination unit 103 of the transfer device controller 2a is similar to the processing in steps S106 and S107 illustrated in FIG. 5. Furthermore, processing in steps S310 and S311 by the transfer control unit 101 of each transfer device 1a is similar to processing in steps S108 and S109 illustrated in FIG. 5. Thus, the processing executed by the signal transfer system 100c illustrated in the flowchart of FIG. 21 ends.

As the second application example of the second modification, the signal transfer system 100b may further include the wireless controller 5. The wireless controller 5 controls operation of the distributed station 4a. Hereinafter, the signal transfer system 100 including the wireless controller 5 will be described. Hereinafter, the signal transfer system 100b including the wireless controller 5 will be referred to as a signal transfer system 100d.

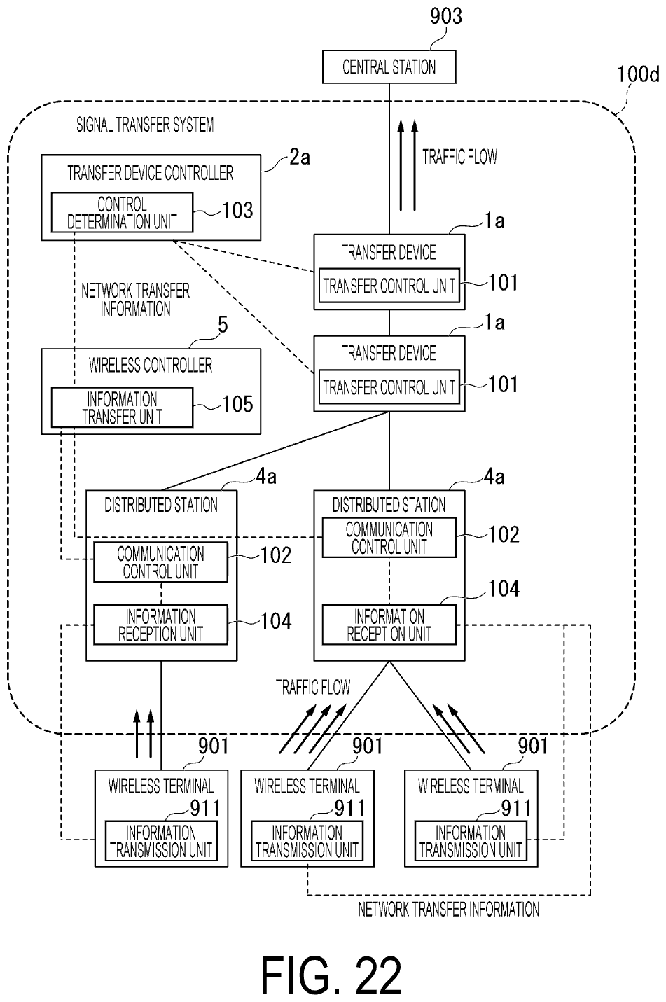

FIG. 22 is a block diagram illustrating the second application example of the signal transfer system according to the second modification of the embodiment. The signal transfer system 100d is different from the signal transfer system 100b in including the wireless controller 5. The wireless controller 5 controls operation of the distributed station 4a. The wireless controller 5 includes an information transfer unit 105. The information transfer unit 105 included in the wireless controller 5 receives network transfer information transmitted from the communication control unit 102 included in the distributed station 4a. The information transfer unit 105 included in the wireless controller 5 transfers the received network transfer information to the control determination unit 103 of the transfer device controller 2a.

As described above, the control determination unit 103 of the transfer device controller 2a may acquire the network transfer information not directly from the communication control unit 102 of the distributed station 4a but via the information transfer unit 105 included in the wireless controller 5.

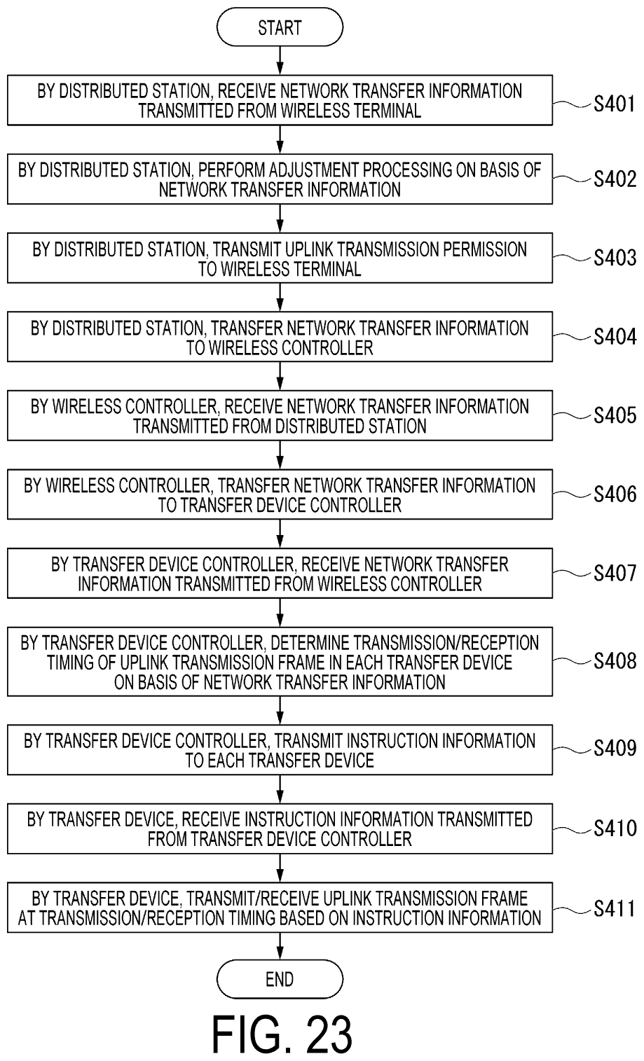

FIG. 23 is a flowchart illustrating an example of a flow of processing executed by the signal transfer system 100d according to the second application example of the second modification. More specifically, an example of a flow of processing executed by the signal transfer system 100d in a case where a signal is transmitted from the wireless terminal 901 to the server 902 will be described. In the signal transfer system 100d, the processing illustrated in FIG. 23 is repeatedly performed.

The information reception unit 104 included in each distributed station 4a receives network transfer information transmitted from the wireless terminal 901 that faces its own device (distributed station 4a) (step S401). The information reception unit 104 outputs the received network transfer information to the communication control unit 102 of its own device (distributed station 4a). The communication control unit 102 acquires the network transfer information output from the information reception unit 104. The communication control unit 102 performs adjustment processing on the basis of the acquired network transfer information (step S402). The adjustment processing is processing of performing one or both of the TDD timing adjustment processing and the TBS adjustment processing.

The communication control unit 102 of the distributed station 4a sends back information indicating uplink transmission permission to the wireless terminal 901 (that has transmitted the network transfer information to its own device (distributed station 4a)) on the basis of the result of the adjustment processing (step S403). Furthermore, the communication control unit 102 transfers the acquired network transfer information to the wireless controller 5 (step S404).

The information transfer unit 105 of the wireless controller 5 receives the network transfer information transmitted from each distributed station 4a (step S405). The communication control unit 102 transfers the acquired network transfer information to the transfer device controller 2a (step S406).

The control determination unit 103 of the transfer device controller 2a receives the network transfer information transmitted from the wireless controller 5 (step S407).

Subsequent processing in steps S408 and S409 by the control determination unit 103 of the transfer device controller 2a is similar to the processing in steps S206 and S207 illustrated in FIG. 7. Furthermore, processing in steps S410 and S411 by the transfer control unit 101 of each transfer device 1a is similar to processing in steps S208 and S209 illustrated in FIG. 7. Thus, the processing executed by the signal transfer system 100c illustrated in the flowchart of FIG. 23 ends.

### <Example of Hardware Configuration of Wireless Controller>

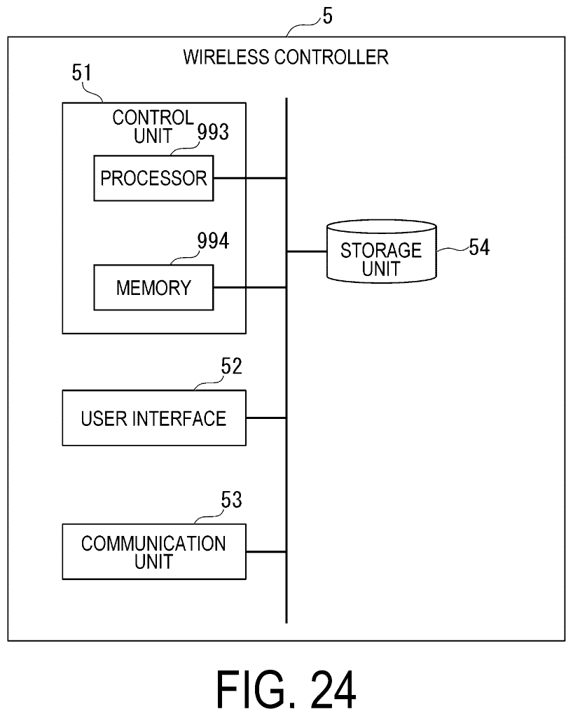

FIG. 24 is a diagram illustrating an example of a hardware configuration of the wireless controller 5 in the modification. The wireless controller 5 includes a control unit 51 including a processor 993 such as a CPU and a memory 994 connected via a bus, and executes a program. The wireless controller 5 functions as a device including the control unit 51, a user interface 52, a communication unit 53, and a storage unit 54 by executing the program.

More specifically, in wireless controller 5, the processor 993 reads the program stored in the storage unit 54, and stores the read program in the memory 994. When the processor 993 executes the program stored in the memory 994, the wireless controller 5 functions as a device including the control unit 51, the user interface 52, the communication unit 53, and the storage unit 54.

The control unit 51 controls operation of various functional units included in the wireless controller 5. The user interface 52 includes an input device such as a mouse, a keyboard, or a touch panel. The user interface 52 may include an interface that connects such an input device to the wireless controller 5.

The user interface 52 includes a display device such as a CRT display, a liquid crystal display, or an organic EL display, for example. The user interface 52 may include an interface that connects such a display device to the wireless controller 5.

The communication unit 53 includes an interface that connects the wireless controller 5 to an external device. The communication unit 53 communicates with an external device in a wired or wireless manner. The external device is, for example, the transfer device controller 2a. The communication unit 53 acquires network transfer information through communication with the transfer device controller 2a. The external device is, for example, the base station 3a or the distributed station 4a. The communication unit 53 transmits network transfer information to, for example, the base station 3a or the distributed station 4a.

The storage unit 54 is configured by using a computer-readable storage medium device such as a magnetic hard disk device or a semiconductor storage device. The storage unit 54 stores various types of information regarding the wireless controller 5. The storage unit 54 stores, for example, various types of information generated as a result of processing executed by the control unit 51.

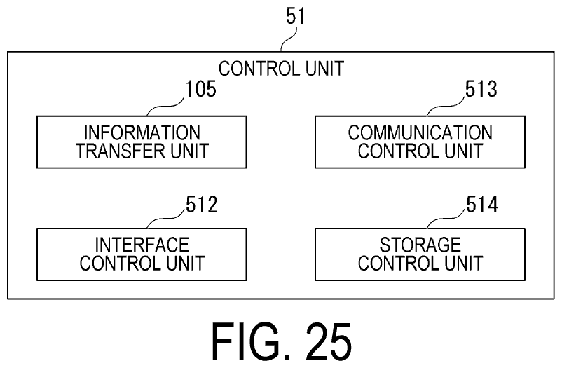

FIG. 25 is a diagram illustrating an example of a configuration of a control unit 51 included in the wireless controller 5 according to the modification. The control unit 51 includes an information transfer unit 105, an interface control unit 512, a communication control unit 513, and a storage control unit 514. The information transfer unit 105 transfers network transfer information acquired from the communication control unit 102 of the distributed station 4a to the control determination unit 103 of the transfer device controller 2a. The interface control unit 512 controls operation of the user interface 52. The communication control unit 513 controls operation of the communication unit 53. The storage control unit S14 controls operation of the storage unit 54.

Note that each of the devices included in each of the signal transfer system 100 and the signal transfer systems 100a to 100d in the above-described embodiment and the modifications thereof may be implemented using a plurality of information processing devices communicably connected via a network.

According to the above-described embodiment, the signal transfer system is a system that transfers a signal from one communication device to the other communication device. For example, the signal transfer system is the signal transfer system 100a to the signal transfer system 100d in the embodiment, one communication device is the wireless terminal 901 in the embodiment, and the other communication device is the server 902 or the central station 903 in the embodiment. The signal transfer system includes an information acquisition unit (an information acquisition acquirer) and a communication control unit (a communication controller). For example, the information acquisition unit is the information reception unit 104 in the embodiment, and the communication control unit is the communication control unit 102 in the embodiment.

The information acquisition unit acquires network transfer information that is information regarding a traffic flow for each traffic flow from one communication device to the other communication device from the one communication device. The communication control unit executes adjustment processing of controlling transmission of a frame in one communication device so as to reduce a waiting time for a frame on the basis of the network transfer information acquired by the information acquisition unit. For example, the frame is an uplink transmission frame in the embodiment.

Note that the signal transfer system may further include a transfer unit (a transmitter) and a transfer control unit (a transfer controller). For example, the transfer unit is the transfer device 1a in the embodiment, and the transfer control unit is the transfer device controller 2a in the embodiment. The transfer unit transfers a signal. For example, the signal is an uplink transmission frame in the embodiment. The transfer control unit executes adjustment processing of controlling transfer of a frame in the transfer unit so as to reduce a waiting time for a frame on the basis of the network transfer information acquired by the information acquisition unit. For example, the frame is an uplink transmission frame in the embodiment.

Note that, in the signal transfer system, the communication control unit may execute analysis processing of averaging values regarding a state of a frame or analysis processing of predicting a future state of a frame on the basis of network transfer information.

According to the above-described embodiment, the signal transfer system is a system that transfers a signal from one communication device to the other communication device. For example, the signal transfer system is the signal transfer system 100a to the signal transfer system 100d in the embodiment, one communication device is the wireless terminal 901 in the embodiment, and the other communication device is the server 902 or the central station 903 in the embodiment. The signal transfer system includes a transfer unit (a transmitter), an information acquisition unit, and a transfer control unit. For example, the transfer unit is the transfer device 1a in the embodiment, the information acquisition unit is the information reception unit 104 in the embodiment, and the transfer control unit is the transfer device controller 2a in the embodiment.

The transfer unit transfers a signal. For example, the signal is an uplink transmission frame in the embodiment. The information acquisition unit acquires network transfer information that is information regarding a traffic flow for each traffic flow from one communication device to the other communication device from the one communication device. The transfer control unit executes adjustment processing of controlling transfer of a frame in the transfer unit so as to reduce a waiting time for a frame on the basis of the network transfer information acquired by the information acquisition unit. For example, the frame is an uplink transmission frame in the embodiment.

Note that, in the signal transfer system, the adjustment processing may be one or both of time division duplex (TDD) timing adjustment processing of adjusting a frame transmission timing that is a timing at which a frame is transmitted in TDD according to a predetermined rule set in advance and transport block size (TBS) adjustment processing of adjusting a TBS according to a predetermined rule set in advance.

Note that, in the signal transfer system, one communication device may be a wireless terminal, and the frame transmission timing may be a timing at which an uplink transmission frame that is a frame transmitted from the wireless terminal to the other communication device is transmitted.

Furthermore, according to the above-described embodiment, the base station device is a device that is wirelessly connected to one communication device and transfers a signal transmitted from the one communication device to the other communication device. For example, the base station device is the base station 3a or the distributed station 4a in the embodiment, one communication device is the wireless terminal 901 in the embodiment, and the other communication device is the server 902 or the central station 903 in the embodiment. The base station device includes an information acquisition unit (an information acquirer) and a communication control unit (a communication controller). For example, the information acquisition unit is the information reception unit 104 in the embodiment, and the communication control unit is the communication control unit 102 in the embodiment.

The information acquisition unit acquires network transfer information that is information regarding a traffic flow for each traffic flow from one communication device to the other communication device from the one communication device. The communication control unit executes adjustment processing of controlling transmission of a frame in one communication device so as to reduce a waiting time for a frame on the basis of the network transfer information acquired by the information acquisition unit. For example, the frame is an uplink transmission frame in the embodiment.

Furthermore, according to the above-described embodiment, the base station device is a device that is wirelessly connected to one communication device and transfers a signal transmitted from the one communication device to the other communication device. For example, the base station device is the base station 3a or the distributed station 4a in the embodiment, one communication device is the wireless terminal 901 in the embodiment, and the other communication device is the server 902 or the central station 903 in the embodiment. The base station device includes an information acquisition unit (an information acquirer) and an information transmission unit (an information transmitter). For example, the information acquisition unit is the information reception unit 104 in the embodiment, and the information transmission unit is the communication control unit 102 in the embodiment.

The information acquisition unit acquires network transfer information that is information regarding a traffic flow for each traffic flow from one communication device to the other communication device from the one communication device. The information transmission unit transmits network transfer information to a transfer control device that executes adjustment processing of controlling transfer of a frame on the basis of the network transfer information so as to reduce a waiting time for a frame in a transfer unit that transfers a signal. For example, the transfer unit is the transfer device 1a in the embodiment, the frame is an uplink transmission frame in the embodiment, and the transfer control device is the transfer device controller 2a in the embodiment.

Furthermore, according to the above-described embodiment, the transfer control device is a device that controls a transfer unit that transfers a signal transmitted from one communication device to the other communication device. For example, the transfer control device is the transfer device controller 2a in the embodiment, the one communication device is the wireless terminal 901 in the embodiment, the other communication device is the server 902 or the central station 903 in the embodiment, and the transfer unit is the transfer device 1a in the embodiment. The transfer control device includes an information acquisition unit (an information acquirer) and a transfer control unit (a transfer controller). For example, the information acquisition unit and the transfer control unit are the control determination unit 103 in the embodiment.

The information acquisition unit acquires network transfer information that is information regarding a traffic flow from a base station device wirelessly connected to one communication device for each traffic flow from the one communication device to the other communication device. For example, the base station device is the base station 3a or the distributed station 4a in the embodiment. The transfer control unit executes adjustment processing of controlling transfer of a frame in the transfer unit so as to reduce a waiting time for a frame on the basis of the network transfer information acquired by the information acquisition unit. For example, the frame is an uplink transmission frame in the embodiment.

Note that all or some of the functions of the devices included in each of the signal transfer system 100 and the signal transfer systems 100a to 100d in the above-described embodiment and the modifications thereof may be implemented using hardware such as an application specific integrated circuit (ASIC), a programmable logic device (PLD), or a field programmable gate array (FPGA). The program may be recorded on a computer-readable recording medium. The computer-readable recording medium is, for example, a portable medium such as a flexible disk, a magneto-optical disk, a ROM, or a CD-ROM or a storage device such as a hard disk built in a computer system. The program may be transmitted via an electrical communication line.

Although the embodiment of the present invention has been described above in detail with reference to the drawings, the specific configuration is not limited to the embodiment, and includes design and the like within a range not departing from the gist of the present invention.

### REFERENCE SIGNS LIST

1a Transfer device
2a Transfer device controller
3a Base station
4a Distributed station
5 Wireless controller
11a, 21a, 31a, 41a, 51, 910, 910a Control unit
12, 22, 32, 42, 52, 920, 920a User interface
13, 23, 33, 43, 53, 930, 930a Communication unit
14, 24, 34, 44, 54, 940, 940a Storage unit
91a, 93a, 95a, 97a, 991, 993 Processor
92a, 94a, 96a, 98a, 992, 994 Memory
100, 100a, 100b, 100c, 100d Signal transfer system
101 Transfer control unit
102, 113, 213, 513, 913 Communication control unit
103 Control determination unit
104 Information reception unit
105 Information transfer unit
112, 212, 312, 412, 512, 912 Interface control unit
114, 214, 314, 414, 514, 914 Storage control unit
900 Communication device
901 Wireless terminal
902 Server
903 Central station
911 Information transmission unit

1. A signal transfer system that transfers a signal from one communication device to another communication device, the signal transfer system comprising:
an information acquirer that acquires network transfer information that is information regarding a traffic flow from the one communication device for each traffic flow from the one communication device to the another communication device; and
a communication controller that executes adjustment processing of controlling transmission of a frame in the one communication device so as to reduce a waiting time for the frame on a basis of the network transfer information acquired by the information acquirer.

2. The signal transfer system according to claim 1 further comprising:
a transmitter that transfers the signal; and
a transfer controller that executes adjustment processing of controlling transfer of a frame in the transmitter so as to reduce a waiting time for the frame on a basis of the network transfer information acquired by the information acquirer.

3. A signal transfer system that transfers a signal from one communication device to another communication device, the signal transfer system comprising:
a transmitter that transfers the signal;
an information acquirer that acquires network transfer information that is information regarding a traffic flow from the one communication device for each traffic flow from the one communication device to the another communication device; and
a transfer controller that executes adjustment processing of controlling transfer of a frame in the transmitter so as to reduce a waiting time for the frame on a basis of the network transfer information acquired by the information acquirer.

4. A base station device that is wirelessly connected to one communication device and transfers a signal transmitted from the one communication device to another communication device, the base station device comprising:
an information acquirer that acquires network transfer information that is information regarding a traffic flow from the one communication device for each traffic flow from the one communication device to the another communication device; and
a communication controller that executes adjustment processing of controlling transmission of a frame in the one communication device so as to reduce a waiting time for the frame on a basis of the network transfer information acquired by the information acquirer.

5. A base station device that is wirelessly connected to one communication device and transfers a signal transmitted from the one communication device to another communication device, the base station device comprising:
an information acquirer that acquires network transfer information that is information regarding a traffic flow from the one communication device for each traffic flow from the one communication device to the another communication device; and
an information transmitter that transmits the network transfer information to a transfer control device that executes adjustment processing of controlling transfer of a frame on a basis of the network transfer information so as to reduce a waiting time for the frame in a transmitter that transfers the signal.

6. A transfer control device that controls a transmitter that transfers a signal transmitted from one communication device to another communication device, the transfer control device comprising:
an information acquirer that acquires network transfer information that is information regarding a traffic flow from a base station device wirelessly connected to the one communication device for each traffic flow from the one communication device to the another communication device; and
a transfer controller that executes adjustment processing of controlling transfer of a frame in the transmitter so as to reduce a waiting time for the frame on a basis of the network transfer information acquired by the information acquirer.

7. A signal transfer method for transferring a signal from one communication device to another communication device, the signal transfer method comprising:
acquiring network transfer information that is information regarding a traffic flow from the one communication device for each traffic flow from the one communication device to the another communication device; and
executing adjustment processing of controlling transmission of a frame in the one communication device so as to reduce a waiting time for the frame on a basis of the network transfer information acquired.

8. A signal transfer method for transferring a signal from one communication device to another communication device, the signal transfer method comprising:
transferring the signal;
acquiring network transfer information that is information regarding a traffic flow from the one communication device for each traffic flow from the one communication device to the another communication device; and
executing adjustment processing of controlling transfer of a frame so as to reduce a waiting time for the frame on a basis of the network transfer information acquired.
